(19) United States
(12) Patent Application Publication
(10) Pub. No.: US 2014/0280311 A1
(43) Pub. Date: Sep. 18, 2014

(54) CLOUD PLATFORM AND DATA EXCHANGING METHOD

(71) Applicant: Quanta Computer Inc., Tao Yuan Shien (TW)

(72) Inventors: Tien-Chin FANG, Taoyuan County (TW); Chen-Chung LEE, Nantou County (TW); Ping-Chi LAI, Taoyuan County (TW); Ching-Shium CHEN, New Taipei City (TW); Kun-Ping KUO, New Taipei City (TW); Meng-Chia CHEN, Taipei City (TW)

(73) Assignee: Quanta Computer Inc., Tao Yuan Shien (TW)

(21) Appl. No.: 13/920,560

(22) Filed: Jun. 18, 2013

(30) Foreign Application Priority Data
Mar. 18, 2013 (TW) 102109407

(51) Int. Cl. G06F 17/30

(52) U.S. Cl. CPC G06F 17/30864
USPC 707/769

(57) ABSTRACT

A cloud platform comprises a first tenant server, a second tenant server, a first tenant database, a second tenant database, and a cloud data exchanging system. The first tenant server and the second tenant server are coupled to the first client and the second client respectively. The first tenant database and the second tenant database are respectively coupled to the first tenant server and the second tenant server via the cloud data exchanging system. The cloud data exchanging system, after receiving a query request from the second client via the second tenant server, determines whether the data relation table has any data links belonging to the second client. If so, the cloud data exchanging system finds database information from a database connection table according to the data link and enters the first tenant database according to the database information.

This application claims the benefit of Taiwan application Serial No. 102109407, filed Mar. 18, 2013, the subject matter of which is incorporated herein by reference.

### BACKGROUND OF THE INVENTION

1. Field of the Invention

The invention relates in general to an electronic apparatus, and more particularly to a cloud platform and a data exchanging method thereof.

2. Description of the Related Art

Referring to FIG. 1, a schematic diagram of a conventional multi-tenant architecture is shown. In a conventional multi-tenant architecture, the conventional cloud platform 1 comprises tenant servers 11A˜11N and tenant databases 12A˜12N. The tenant databases 12A˜12N respectively store the data of tenant servers 11A˜11N. Clients 3A˜3N respectively use the cloud service provided by the conventional cloud platform 1 via the tenant servers 11A˜11N. Each client has an independent tenant server and an independent tenant database. For example, client 3A has exclusive use of the tenant server 11A and the tenant database 12A, and client 3B has exclusive use of the tenant server 11B and the tenant database 12B. The client server and the tenant database used by one client are independent from and not interfering with that used by another client.

However, business-to-business (B2B) connection must be established for the purpose of exchanging data between the clients 3A˜3N. To establish conventional B2B connection, the specifications, formats and columns of both parties must firstly be defined and the data of both parties must be periodically synchronized by a program, not only incurring additional establishment cost but also requiring a waiting time for the synchronization of exchange data to be completed

### SUMMARY OF THE INVENTION

The invention is directed to a cloud platform and a data exchanging method thereof.

According to an embodiment of the present invention, a cloud platform is disclosed. The cloud platform is coupled to a first client and a second client, and comprises a first tenant server, a second tenant server, a first tenant database, a second tenant database, and a cloud data exchanging system. The first tenant server is coupled to the first client. The second tenant server is coupled to the second client. The first tenant database stores the data of the first tenant server. The second tenant database stores the data of the second tenant server. The first tenant database and the second tenant database are respectively coupled to the first tenant server and the second tenant server via the cloud data exchanging system. The cloud data exchanging system, after receiving a query request sent from the second client via the second tenant server, determines whether the data relation table has any data links belonging to the second client. If the data relation table has a data link belonging to the second client, the cloud data exchanging system finds database information from a database connection table according to the data link and enters the first tenant database according to the database information.

According to another embodiment of the present invention, a data exchanging method of a cloud platform is disclosed. The cloud platform is coupled to the first client and the second client. The cloud platform comprises a first tenant server, a second tenant server, a first tenant database, a second tenant database, and a cloud data exchanging system. The first tenant database and the second tenant database are respectively coupled to the first tenant server and the second tenant server via the cloud data exchanging system. The data connection method comprises: determining whether the data relation table has any data links belonging to the second client by the cloud data exchanging system after receiving a query request sent from the second client via the second tenant server; finding the database information from a database connection table according to the data link; entering the first tenant database according to the database information if the data relation table has a data link belonging to the second client.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 shows a schematic diagram of a conventional multi-tenant architecture;

FIG. 2 shows a schematic diagram of a cloud platform according to a first embodiment;

FIG. 3 shows a flowchart of a database connection table generation method according to an embodiment;

FIG. 4 shows a flowchart of a method for generating a partner relation table according to an embodiment;

FIG. 5 shows a flowchart of a method for generating a data relation table according to an embodiment;

FIG. 6 shows a flowchart of a data exchanging method of a cloud platform according to an embodiment.

### DETAILED DESCRIPTION OF THE INVENTION

Referring to FIG. 2, a schematic diagram of a cloud platform according to a first embodiment is shown. The cloud platform 2 is coupled to clients 3A˜3N. The cloud platform 2 comprises tenant servers 21A˜21N, tenant database 22A˜22N and a cloud exchange system 23. The tenant servers 21A˜21N are connected to the clients 3A˜3N respectively, and the tenant database 22A˜22N store the data of tenant servers 21A˜21N respectively. The tenant database 22A˜22N are coupled to tenant servers 21A˜21N respectively via the cloud data exchanging system 23. The cloud exchange system 23 comprises an exchange server 231 and an exchange database 232.

The exchange database 232 stores a database connection table, a partner relation table and a data relation table. The data relation table is generated according to the partner relation table. The exchange server 231, after receiving a query request sent from one of tenant servers 21A˜21N, determines whether the database connection table has any data links belonging to the client. If the data relation table has a data link belonging to the client, then the exchange server 231 finds database information from the database connection table according to the data link and enters the tenant database belonging to another client according to the database information. For example, the exchange server 231, after receiving the query request sent from the client 3B via the tenant server 21B, determines whether the database connection table has the data link belonging to client 3B. If the data relation table has a data link belonging to client 3B, then the exchange server 231 finds database information from the database connection table according to the data link and enters the tenant database 22A according to the database information.

Referring to FIG. 2, FIG. 3 and Table 1. FIG. 3 shows a flowchart of a database connection table generation method according to an embodiment. The database connection table comprises a plurality of database links. Each the database link comprises a service identification (SID), a user identification (UID) and a database information. The service identification represents the cloud service provided by the cloud platform 2. The cloud service is such as the order cloud service, the e-sale cloud service, the auction cloud service and the custom cloud service. For example, the service identification S01 represents the order cloud service; the service identification S02 represents the e-sale cloud service; the service identification S03 represents the auction cloud service. Each client has its unique user identification. For example, user identification A represents client 3A; user identification B represents client 3B; user identification C represents client 3C; user identification D represents client 3D.

The database information is the account number and password used by each client for entering the database. For example, when the client 3A would like to use the order cloud service, the client 3A needs to use the database information X1 for entering the tenant database 22A. Similarly, when the client 3B would like to use the order cloud service, the client 3B needs to use the database information X2 for entering the tenant database 22B. When the client 3C would like to use the order cloud service, the client 3C needs to use the database information X3 for entering the tenant database 22C. When the client 3B would like to use e-sale cloud service, the client 3B needs to use the database information X4 for entering the tenant database 22B. When the client 3C would like to use e-sale cloud service, the client 3C needs to use the database information X5 for entering the tenant database 22C. When the client 3D would like to use auction cloud service, the client 3D needs to use the database information X6 for entering the tenant database 22D.

TABLE 1
Database Connection Table

| Service Identification | User Identification | Database Information |
|---|---|---|
| S01 | A | X1 |
| S01 | B | X2 |
| S01 | C | X3 |
| S02 | B | X4 |
| S02 | C | X5 |
| S03 | D | X6 |

The method for generating a database connection table comprises steps 41˜44. Firstly, the process begins at step 41, one of the clients 3A˜3N joins the cloud platform 2. Then, the process proceeds to step 42, the client obtains a service identification. Then, the process proceeds to step 43, the client registers a database information on the cloud data exchanging system 23. Then, the process proceeds to step 44, the cloud data exchanging system 23 records the database information in the database connection table. For example, the client 3A, after joining the cloud platform 2, obtains the service identification S01 and registers the database information X1 on the cloud data exchanging system 23, and the cloud data exchanging system 23 records the database information X1 in the database connection table.

Referring to FIG. 2, FIG. 4 and Table 2. FIG. 4 shows a flowchart of a method for generating a partner relation table according to an embodiment. The partner relation table comprises a plurality of partner links. Each partner link comprises a target user identification, a service identification and a source user identification. The source user identification and the target user identification represent a source client and a target client respectively. The source client is the client who provides exchange data, and the target client is another client who has gained the source client's permission for inquiring the exchange data. For example, the client 3A and the user 3B have a partner relationship when using the order cloud service. In the partner relation table, when both the service identification is S01 and the target user identification are A, the source user identification are B. In the partner relation table, when both the service identification is S01 and the target user identification are B, the source user identification is A.

TABLE 2
Partner Relation Table

| Target User | | |
|---|---|---|
| Identification | Service Identification | Source User Identification |
| A | S01 | B |
| B | S01 | A |
| A | S01 | C |
| C | S01 | A |
| B | S02 | C |
| C | S02 | B |

The method for generating a partner relation table comprises steps 51˜54. Firstly, the process begins at step 51, a data exchange partner is selected. Next, the process proceeds to step 52, an invitation is sent. Then, the process proceeds to step 53, a partner link is established after the invitation is accepted by the data exchange partner. Then, the process proceeds to step 54, the cloud data exchanging system 23 records the partner link in the partner relation table. For example, the client 3A selects the client 3B as a data exchange partner, and sends an invitation to client 3B via the cloud platform 2. After the invitation is accepted client 3B, the cloud data exchanging system 23 establishes a partner link, and further records the partner link in the partner relation table.

Referring to FIG. 2, FIG. 5 and Table 3. FIG. 5 shows a flowchart of a method for generating a data relation table according to an embodiment. The data relation table comprises a plurality of data links. Each the data link comprises a record identification (RID), a target user identification, a service identification and a source user identification. Different record identification represents different exchange data. When the record identification, the target user identification, the service identification and the source user identification are R01, B, S01 and A respectively, this implies that the client 3A allows the client 3B to inquire the exchange data corresponding to the record identification R01 via the cloud platform 2.

TABLE 3
Data Relation Table

| Source User | Service | Record | Target User |
|---|---|---|---|
| Identification | Identification | Identification | Identification |
| A | S01 | R01 | B |
| A | S01 | R01 | C |
| A | S01 | R03 | B |
| A | S01 | R05 | B |
| A | S01 | R05 | C |
| B | S01 | R13 | A |
| B | S01 | R13 | C |
| B | S01 | R16 | C |
| C | S01 | R27 | B |
| C | S01 | R28 | B |
| A | S02 | R87 | B |
| A | S02 | R88 | C |

The method for generating a data relation table comprises steps 61˜64. Firstly, the process begins at step 61, exchange data is selected. Next, the process proceeds to step 62, a data exchange partner is selected. Then, the process proceeds to step 63, whether a partner link exists is determined by the cloud data exchanging system 23. If the partner link does not exist, then the process proceeds to step 62 again and the client is requested to re-select the data exchange partner. Then, the process proceeds to step 64, the cloud data exchanging system 23 stores the data link in the data relation table. For example, the client 3A selects the exchange data corresponding to the record identification R01, and selects the client 3B as the data exchange partner. The cloud data exchanging system 23 determines whether the partner link of the client 3B exists according to the partner relation table. If the partner link does not exist, this implies that there is no partner relationship existing between the client 3A and the client 3B, and the cloud data exchanging system 23 requests the client 3A to re-select the data exchange partner. If the partner link exists, this implies that there is a partner relationship existing between the client 3A and the client 3B, and the cloud data exchanging system 23 records the data link in the data relation table.

Referring to FIG. 2, FIG. 6, Table 1 and Table 3. FIG. 6 shows a flowchart of a data exchanging method of a cloud platform according to an embodiment. The data exchanging method of the cloud platform 2 comprises steps 71˜75. Firstly, the process begins at step 71, a query request is received by the cloud data exchanging system 23. Next, the process proceeds to step 72, whether the data relation table has any data links belonging to the client who sends the query request is determined by the cloud data exchanging system 23. If the data relation table does not have any corresponding data links, then the process proceeds to step 75. In step 75, the cloud data exchanging system 23 responds to the client who sends the query request that there is no data exchange. Conversely, if the data relation table has a corresponding data link, then the process proceeds to step 73. In step 73, the cloud data exchanging system 23 finds database information from the database connection table according to the data link. Then, the process proceeds to step 74, the cloud data exchanging system 23 enters the corresponding tenant database according to the database information.

For example, the cloud data exchanging system 23, after receiving the query request sent by the client 3B via the tenant server 21B, determines whether the data relation table has any data links belonging to the client 3B. As indicated in Table 3, there are 6 data links belonging to the client 3B. Let the first data link of Table 3 be taken for example. The cloud data exchanging system 23 finds the database information X1 from the database connection table according to the data link, and enters the tenant database 22A according to the database information X1. Furthermore, the cloud data exchanging system 23 finds the corresponding source user identification A from the first data link of the data relation table according to the service identification S01 and the target user identification B of the client 3B. The cloud data exchanging system 23 again finds the corresponding database information X1 from the database connection table according to the service identification S01 and the source user identification A of the client 3B. The cloud data exchanging system 23, after finding the database information X1, enters the tenant database 22A to read the exchange data.

To establish a conventional business-to-business (B2B) connection, the specifications, formats and columns of both parties must firstly be defined and the data of both parties must be periodically synchronized by a program. In comparison to the conventional B2B connection, the cloud platform and the data exchanging method thereof disclosed in above embodiments can possess B2B function without additionally establishing a B2B connection. Moreover, the target client can instantly inquire the exchange data of the source client without requiring a waiting time for the synchronization of exchange data to be completed.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A cloud platform coupled to a first client and a second client, wherein the cloud platform comprises:
a first tenant server coupled to the first client;
a second tenant server coupled to the second client;
a first tenant database used for storing the data of the first tenant server;
a second tenant database used for storing the data of the second tenant server; and
a cloud data exchanging system via which the first tenant database and the second tenant database are coupled to the first tenant server and the second tenant server respectively, wherein the cloud data exchanging system, after receiving a query request sent from the second client via the second tenant server, determines whether a data relation table has a data link belonging to the second client: if the data relation table has a data link belonging to the second client, the cloud data exchanging system finds a database information from a database connection table according to the data link and enters the first tenant database according to the database information.

2. The cloud platform according to claim 1, wherein if the data relation table does not have a data link belonging to the second client, the cloud data exchanging system responds to the second client via the second tenant server that there is no data exchange.

3. The cloud platform according to claim 1, wherein the cloud data exchanging system comprises:
an exchange database used for storing the database connection table, a partner relation table and the data relation table, wherein the data relation table is generated according to the partner relation table; and
an exchange server used for determining whether the database connection table has any data links belonging to the second client after receiving the query request, wherein if the data relation table has a data link belonging to the second client, the cloud data exchanging system finds database information from the database connection table according to the data link and enters the first tenant database according to the database information.

4. The cloud platform according to claim 1, wherein the data link comprises a service identification, a source user identification and a target user identification, the cloud data exchanging system finds the corresponding source user identification from the data relation table according to the service identification and the target user identification of the second client.

5. The cloud platform according to claim 4, wherein the cloud data exchanging system finds the corresponding database information from the database connection table according to the service identification and the source user identification of the second client.

6. The cloud platform according to claim 1, wherein the first client, after joining the cloud platform, obtains the service identification, and registers the database information on the cloud data exchanging system, which records the database information in the database connection table.

7. The cloud platform according to claim 1, wherein the first client selects the second client as a data exchange partner and sends an invitation to the second client, and the cloud data exchanging system establishes a partner link and further records the partner link in a partner relation table after the second client accepted the invitation.

8. The cloud platform according to claim 7, wherein the first client selects an exchange data and further selects the second client as the data exchange partner, and the cloud data exchanging system determines whether the partner link of the second client exists according to the partner relation table: if the partner link exists, the cloud data exchanging system records the data link in the data relation table.

9. The cloud platform according to claim 8, wherein if the partner link does not exist, the cloud data exchanging system requests the first client to re-select the data exchange partner.

10. A data exchanging method of a cloud platform, wherein the cloud platform is coupled to a first client and a second client, and comprises a first tenant server, a second tenant server, a first tenant database, a second tenant database and a cloud data exchanging system, the first tenant database and the second tenant database are respectively coupled to the first tenant server and the second tenant server via the cloud data exchanging system, and the data connection method comprises:
determining whether the data relation table has any data links belonging to the second client by the cloud data exchanging system after a query request sent from the second client via the second tenant server is received by the cloud data exchanging system;
finding the database information from a database connection table according to the data link if the data relation table has a data link belonging to the second client; and
entering the first tenant database according to the database information.

11. The data exchanging method according to claim 10, wherein if the data relation table does not have the data link belonging to the second client, the cloud data exchanging system responds to the second client via the second tenant server that there is no data exchange.

12. The data exchanging method according to claim 10, wherein the cloud data exchanging system comprises:
an exchange database used for storing the database connection table, a partner relation table and the data relation table, wherein the data relation table is generated according to the partner relation table; and
an exchange server used for determining whether the database connection table has any data links belonging to the second client after receiving the query request, wherein if the data relation table has a data link belonging to the second client, the cloud data exchanging system finds database information from the database connection table according to the data link and enters the first tenant database according to the database information.

13. The data exchanging method according to claim 10, wherein the data link comprises a service identification, a source user identification and a target user identification, the cloud data exchanging system finds the corresponding source user identification from the data relation table according to the service identification and the target user identification of the second client.

14. The data exchanging method according to claim 13, wherein the cloud data exchanging system finds the corresponding database information from the database connection table according to the service identification and the source user identification of the second client.

15. The data exchanging method according to claim 10, the first client, after joining the cloud platform, obtains the service identification, and registers the database information on the cloud data exchanging system, which records the database information in the database connection table.

16. The data exchanging method according to claim 10, wherein the first client selects the second client as a data exchange partner and sends an invitation to the second client, and the cloud data exchanging system establishes a partner link and further records the partner link in a partner relation table after the second client accepted the invitation.

17. The data exchanging method according to claim 16, wherein the first client selects an exchange data and further selects the second client as the data exchange partner, and the cloud data exchanging system determines whether the partner link of the second client exists according to the partner relation table: if the partner link exists, the cloud data exchanging system records the data link in the data relation table.

18. The data exchanging method according to claim 17, wherein if the partner link does not exist, the cloud data exchanging system requests the first client to re-select the data exchange partner.
